(19) United States
(12) Patent Application Publication
(10) Pub. No.: US 2022/0058462 A1
(43) Pub. Date: Feb. 24, 2022

(54) ROTATIONAL COUNTER FOR FLIPPING TOKEN

(71) Applicant: Aharon Lipman, Michmoret (IL)

(72) Inventor: Aharon Lipman, Michmoret (IL)

(21) Appl. No.: 17/413,583

(22) PCT Filed: Jan. 14, 2020
(86) PCT No.: PCT/IL2020/050051

§ 371 Date: Jun. 14, 2021

Related U.S. Application Data
(60) Provisional application No. 62/801,106, filed on Feb. 5, 2019.

(51) Int. Cl. G06M 1/10

(52) U.S. Cl. CPC G06M 1/101

(57) ABSTRACT

Some embodiments disclose a device having two or more sensors and/or a processor that detects a differential between sensor readings and/or determines a flipping of the device based thereon. For example, the sensors may include light sensors. Optionally the device includes an output interface, for example an LCD (liquid crystal display). For example, the display reports flipping statistics. Optionally, the device includes a flat disk and/or is flipped like a coin. Some embodiments disclose a system for communication between a mobile device and a second device. Optionally, the second device includes an imager and/or a light source. Optionally, the mobile device includes an indicator and/or a display. Optionally the second device images the mobile device and/or reads a message on the display and/or determines an orientation of the indicator and/or sends messages to the mobile device via a coded series of flashes.

### RELATED APPLICATION/S

This application claims the benefit of priority under 35 USC § 119(e) of U.S. Provisional Patent Application No. 62/801,106 filed 5 Feb. 2019, the contents of which are incorporated herein by reference in their entirety.

### FIELD AND BACKGROUND OF THE INVENTION

The present invention, in some embodiments thereof, relates to a device for indicating spin statistics and/or counting rotation and more specifically but not limited to a game skill and/or chance.

U.S. Pat. No. 3,630,601 appears to disclose a ball, “provided with a surface pattern of regions of different optical properties. Light reflected from the moving ball is modulated by the rotation of these regions, transformed into a time variable electrical signal in a photocell, and recorded or displayed.”

U.S. Pat. No. 8,655,620 appears to disclose, “a method and a module for measuring rotation and a portable apparatus comprising said module. The module of the present invention is adapted for measuring rotation of a target, and the module includes a first sensor, a second sensor and a processor. The first sensor is disposed at a first location of the target, for sensing a first centripetal acceleration and a first tangential acceleration when the target is rotated. The second sensor is disposed at a second location of the target, for sensing a second centripetal acceleration and a second tangential acceleration when the target is rotated. The processor is coupled to the first sensor and the second sensor, for receiving the first centripetal acceleration and the first tangential acceleration from the first sensor, receiving the second centripetal acceleration and the second tangential acceleration from the second sensor, and calculating the rotation angle of the target accordingly.”

US Patent Published Patent Application no. 20070059675 appears to disclose that, “For measuring the rotational frequency of a movable game device, one resorts to an existing radio signal in the form of a broadcast signal or mobile communication signal within the framework of an open system, or to a radio signal of an evaluation unit within the framework of a closed system, so as to obtain, by means of an antenna having a directivity characteristic, a time-varying radio antenna receive signal which has a low-frequency modulation portion, the frequency of which corresponding to the rotational frequency of the movable game device.”

U.S. Pat. No. 7,037,169 appears to disclose a, “rotating toy having a rotation data measuring means. Data, such as rate of rotation, concerning the rotation of the toy is used to implement amusing games. Various embodiments of the toy of the present invention include a top provided with a synchronized display, a top provided with a transceiver and a top that “walks”.

U.S. Pat. No. 9,286,747 appears to disclose, “casino games that incorporate a player's physical dexterity into gameplay, thus adding a physical skill component to a game, beyond any mental skill components the underlying games already posses. Similarly to the manner in which a player's knowledge of a game's rules and strategies allows the player to increase their chance of winning traditional casino games, the dexterity, or skill-based games allow the player to increase their chance of winning by performing game-oriented physical tasks. Examples of games with this feature are a poker game where a player shoots a game gun at a display device to add cards to their hand in hopes of forming a winning hand, and a three dimensional mahjong game where a player rotates a tile structure to find and removing matching tiles in order to increase their score.”

Other art includes US Published Patent Application no. 20020075475, U.S. Pat. No. 6,367,326.

### SUMMARY OF THE INVENTION

According to an aspect of some embodiments of the invention, there is provided a method of counting rotations of a rotation counting device including: rotating the rotation counting device; measuring a first intensity of a light arriving to the counting device from a first direction with respect to the device; measuring a second intensity of a light arriving to the counting device from substantially different second direction; and calculating a rotation tally of a number of times the rotation counting device rotates about a rotation axis by comparing a series of first light intensities and the second light intensities.

According to some embodiments of the invention, the measuring of a first light intensity is by a first light sensor on the rotation counting device and the measuring the second light intensity is by a second light sensor on the rotation counting device.

According to some embodiments of the invention, the rotating includes throwing the rotating device upward.

According to some embodiments of the invention, the rotating includes applying a differential force on at least two locations on the rotation counting device.

According to some embodiments of the invention, the rotating includes flipping the rotation counting device like a coin.

According to some embodiments of the invention, the calculating is by a calculating unit integral to the rotation counting device.

According to some embodiments of the invention, the first direction and the second direction are determined by at least one member of a group consisting of a position of each of the first sensor and the second sensor on the rotation counting device, a planar alignment of the first sensor and the second sensor relative to each other, light directing slits masking light from at least one direction, polarizing filters and directional light filters.

According to some embodiments of the invention, the calculation of the rotation tally including: generating a time ordered series of pairs of time correlated values of light intensity measured by the first sensor and the second sensor; calculating a time ordered series of differential values from the series pairs by subtracting a value of light intensity measured by the first sensor from a time corresponding value of light intensity measured by the second sensor; calculating a time ordered series of positive threshold values by summing the values of each of the pairs of time series measurements and then dividing each sum by a constant; calculating a time ordered series of negative threshold values by multiplying each member of the positive threshold series by negative one; and calculating a cumulative tally by dividing by two a number of times a difference between time correlated values of the differential series and either of the positive or the negative threshold series changes mathematical sign.

According to some embodiments of the invention, the calculation of the tally further includes applying a mathematical function to the cumulative tally.

According to some embodiments of the invention, the mathematical function includes at least one of an unweighted modulus, a weighted modulus, an average time to flip and a minimum time to flip.

According to some embodiments of the invention, the calculating unit further calculates at least one mode of operation chosen from a group consisting of a cumulative mode wherein results of at least two series of time correlated samples are summed, a game mode wherein at least two series of time correlated samples are summed separately, a dice mode wherein a modulus of a calculated number of rotations is calculated, and a clock mode wherein a number of rotations per unit of time is calculated.

According to an aspect of some embodiments of the invention, there is provided a rotation counting system that counts rotations of a rotation counting device about a rotational axis, including: a first sensor configured to measure light intensity coming from a first direction in relation to the counting device; a second sensor configured to measure light intensity coming from a second direction in relation to the counting device; a rotation counting unit configured to receive a series values of light intensity measurements from the first sensor and the second sensor and to execute an algorithm for calculating a cumulative rotation tally; a communications unit adapted to communicate a series of characters, including the tally; a memory for storing at least one of the instructions, the series values, the cumulative tally and intermediate values used in the calculation; and power source providing electric power to power consuming components of the rotation counting device.

According to some embodiments of the invention, the rotation counting device further includes a control switch to turn off or turn on power to the power consuming components.

According to some embodiments of the invention, the rotation counting unit is integral to the counting device.

According to some embodiments of the invention, the communications unit is integral to the counting device.

According to some embodiments of the invention, the communications unit of the rotation counting device includes at least one member of a group consisting of a screen adapted to displaying characters, a Bluetooth transmitter, a wireless transmitter.

According to some embodiments of the invention, the communications unit of the rotation counting device includes at least one member of a group consisting of an LED screen, an LCD screen and a touch screen.

According to some embodiments of the invention, the communications unit of the rotation counting device includes at least one member of a group consisting of a Wifi transmitter, a radio transmitter, a cellular transmitter.

According to some embodiments of the invention, the first sensor includes at least one member of a group consisting of a photodetector, a photovoltaic sensor, a photo resistor, a proximity light sensor, a photo diode, a photo transistor, a photoemission detector, a thermal sensor, a photochemical detector.

According to some embodiments of the invention, the first sensor includes at least one member of a group consisting of a sensor that converts received electromagnetic radiation into an output signal consisting of at least one of voltage, current, and resistance.

According to an aspect of some embodiments of the invention, there is provided a method for communicating data from a display device to a camera equipped computing device including: Pointing a field of view of a camera of the camera equipped device towards a display area located on a display device; emitting a light signal from the camera equipped device indicating to the display device to begin displaying images of characters; commencing capturing a series of images of the display area with the camera equipped device; receiving the light signal by the display device; displaying on the display area the images including at least one coded data message; and interpreting by the camera equipped device of the at least one coded data message from at least one image from the series of images.

According to some embodiments of the invention, the displaying including displaying a plurality of characters.

According to some embodiments of the invention, the data message including a number of times the display device has completed rotating about a rotation axis.

According to some embodiments of the invention, the camera equipped device identifies an orientation of the display relative to the image by locating on the display device an indicator area distinguishable from a surrounding area of the display device.

According to some embodiments of the invention, the indicator area includes at least one of a group consisting of a reflective area, a glowing area, a textured area, a colored area and a phosphorescent area.

According to some embodiments of the invention, displaying the light signal includes at least one member of a group consisting of emitting light, emitting a series including periods of emitting light and periods of not emitting light, emitting a single light emission including one of at least two predefined light intensities and emitting a series of light emissions wherein each emission including one of at least two predefined light intensities.

According to some embodiments of the invention, at the light signal further includes instruction to the display device relating to a communication protocol between the display device and the camera equipped device.

According to some embodiments of the invention, the instructions to the display device include instructions to perform at least one action from a group of actions consisting of displaying a predefined number of characters, encoding data using a specific set of characters chosen from at least two character sets, a rate of refreshing the displayed characters and ceasing to refresh the characters displayed after a number of times refreshing.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, some embodiments of the present disclosure may take the form of a computer program product embodied in one or more computer readable medium(s) having computer readable program code embodied thereon. Implementation of the method and/or system of some embodiments of the disclosure can involve performing and/or completing selected tasks manually, automatically, or a combination thereof. Moreover, according to actual instrumentation and equipment of some embodiments of methods, systems, and/or computer program products of the present disclosure, several selected tasks could be implemented by hardware, by software or by firmware and/or by a combination thereof, e.g., using an operating system.

For example, hardware for performing selected tasks according to some embodiments of the present disclosure could be implemented as a chip or a circuit. As software, selected tasks according to some embodiments of the present disclosure could be implemented as a plurality of software instructions being executed by a computer using any suitable operating system. In an exemplary embodiment, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

Any combination of one or more computer readable medium(s) may be utilized for some embodiments. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium and/or data used thereby may be transmitted using any appropriate medium, including but not limited to wireless, wireline, optical fiber cable, RF, etc., or any suitable combination of the foregoing.

Computer program code for carrying out operations for some embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Some embodiments of the present disclosure may be described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flow chart illustration of a method of counting rotations of a mobile device in accordance with an embodiment of the current invention;

FIG. 2 is a schematic illustration of a rotation counting device, referred to herein as a spinicator, in accordance with an embodiment of the current invention;

FIG. 3 is a graph illustrating a function showing the light intensity measured by photo sensors as a function of a rotation angle, in accordance with an embodiment of the current invention;

FIG. 4 is a graph illustrating a plurality of functions wherein at least one input of each function may be the relative light intensity of photo sensor, in accordance with an embodiment of the current invention;

FIG. 5 is a block diagram of a spinicator, in accordance with an embodiment of the current invention;

FIG. 6 is flowchart illustration of a method of communicating between two devices using an output interface screen, according to an embodiment of the current invention;

FIG. 7 is an image of a front face of spinicator in accordance with an embodiment of the current invention; and

FIG. 8 is an image of a rear face of spinicator in accordance with an embodiment of the current invention.

### DESCRIPTION

### Overview

The present invention, in some embodiments thereof, relates to a device for indicating spin statistics and/or counting rotation and more specifically but not limited to a game of skill and/or chance.

An aspect of some embodiments of the current invention relates to a device having two or more sensors and a processor that detects a phase delay (e.g. angular phase) between the sensors and/or changes in a function of the relative sensor outputs (for example the function may have a repetitious cycle over each rotation) between the sensors. Optionally, the two sensors may be oriented in different directions. Optionally, the changes of the relative readings may indicate that the device has flipped over. For example, the sensors may include light sensors and/or gravity sensors and/or other kinds of sensors. For example, a difference in angle may range between 65 to 85 degrees and/or between 30 to 65 degrees and/or between 65 to 100 degrees and/or between 1 to 30 degrees and/or between 100 to 140 degrees and/or between 140 to 180 degrees. Optionally the device includes an output interface, for example an LCD (liquid crystal display) that reports statistics on the flipping (the number of cycles in a certain time window, the rate of flips, cumulative number of flips, etc.). For example, the device may be a flat token (e.g. a disk) that is flipped like a coin and reports statistics of flipping.

An aspect of some embodiments relates to a system for communication between a first mobile device having a display and a second device. Optionally, the second device may have an imaging sensor and/or a light source. Optionally, the first mobile device includes a display and/or an indicator area for indicating an orientation of the mobile device. For example, the mobile device may signal a message over the display. The second device may capture one or more images of the mobile device and/or compute the orientation of the display relative to the captured image based on for example the orientation of the indicator area in the image and/or the message on the display from the image. Optionally the indicator area may include a luminous indicator. For example, the indicator may include a phosphorescent indicator. Optionally the second device will charge the phosphorescent material (for example by flashing a light on the mobile device) and then image the indicator and/or the display. In some embodiments the second device will send a coded message to the mobile device via a coded series of flashes.

### Exemplary Embodiments

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

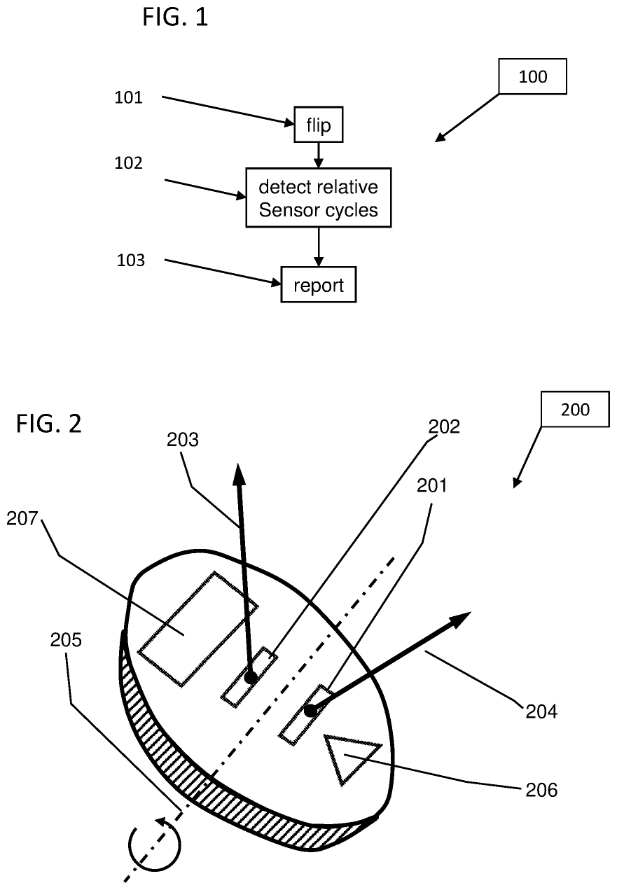

FIG. 1 is a flow chart 100 which illustrates a method of counting rotations of a mobile device in accordance with an embodiment of the current invention. In some embodiments, the mobile device is caused to rotate 101, for example by applying differential forces to different areas of the mobile device. For example, a person may rest the mobile device on one hand and use the thumb to propel the mobile device into the air in the manner of flipping a coin. For example, the mobile device may detect 102 a change of relative measurements between sensors oriented to receive inputs from different angles. In some embodiments, a processor may calculate cycles of a relative difference in the measurements. For example, completing a cycle of relative measurements may indicate that the device has flipped over 360 degrees. In some embodiments the mobile device reports 103 statistics of the calculated completed cycles, indicating a number of times the mobile device has flipped.

In some embodiments, the system may be broken up into different devices. For example, a counting device may be flipped 101 and may send data to an external device (for example a smartphone and/or other personal computing device, for example by wireless communication) and/or processing of the sensor data and/or reporting 103 of the results may be performed by the external device.

FIG. 2 is a schematic illustration of a rotation counting device 200, referred to herein as a spinicator, in accordance with an embodiment of the current invention. In some embodiments spinicator 200 may be shaped like a thin disk and/or may be flipped like a coin around an axis of rotation 205. Rotation axis 205 may be of any orientation, and is defined by the rotation of spinicator 200. Optionally, spinicator comprises sensors 201 and 202, an activation switch 206, and a display 207.

Optionally, spinicator 200 includes at least two sensors, for example sensor 201 and sensor 202. For example, sensor 201 and sensor 202 may include phototransistors, and/or photodetectors, and/or photovoltaic sensors, and/or photo resistors, and/or proximity light sensors, and/or photo diodes, and/or photo transistors, and/or photoemission detectors, and/or thermal sensors, and/or photochemical detectors, and/or any other type of sensor that converts received electromagnetic radiation into an output signal comprising at least one of voltage, current, and resistance.

Optionally each sensor may be directed to receive input originating from different directions, for example direction 203 and direction 204. For example, each sensor may be located behind a slit and/or a hole on or near a surface of spinicator 200. The slit and/or hole may block and/or filter light that is not originating from a selected direction. For example, the difference between direction 203 and direction 204 may be 75 degrees, or may fall within a range of 10 to 20 degrees, or 20 to 50 degrees, or 50 to 75 degrees, or 75 to 100 degrees, or 100 to 180 degrees, or 180 to 360 degrees, Optionally, each of sensor 201 and/or sensor 202 produces a current and/or a resistance and/or a voltage that increases with increasing intensity of light falling on the sensor. Optionally sensors 201 and/or 202 comprise an analog to digital conversion unit, and the output comprises a digital value.

Optionally, spinicator 200 may be caused to rotate in air, for example when flipped in the manner of flipping a coin, as described above in FIG. 1,

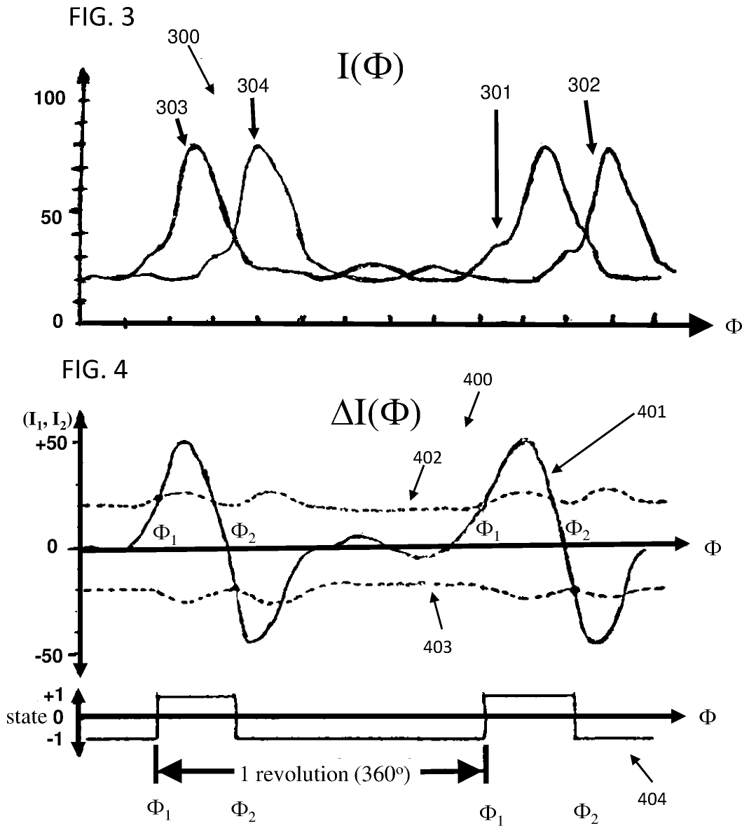

FIG. 3 illustrates a graph 300 of a function showing the light intensity I1 (Φ) 301 measured by photo sensor 201 and the light intensity I2(Φ) 302 measured by photo sensor 202 as a function of a rotation angle Φ, in accordance with an embodiment of the current invention. Angle Φ represents angular displacement of spinicator 200 relative to a plane perpendicular to rotational axis 205. The horizontal axis of graph 300 represents angle Φ, and the vertical axis represents the light intensity measured by sensor 201 and sensor 202. In some embodiments, the ambient light intensity measured by sensor 201 and sensor 202 may change as a function of angle Φ. For example, the light may be brighter from above spinicator 200, or below, or from any other direction. In some embodiments, there may be a light source (e.g. the sun and/or a light bulb) in which case the light intensity may be higher in the direction of the light source. As spinicator 200 rotates about rotational axis 205, each of sensor 201 and sensor 202 are pointed toward and then away from the higher intensity direction. Thus, at a certain angle there may be a peak light intensity measured by either sensor 201 or 202. For example, when spinicator 200 is directed at a first angle Φ₁ sensor 201 is directed toward a peak light intensity direction resulting in peak signal I1 (Φ₁) 303. For example, when spinicator 200 is directed at a second angle Φ₂, for example approximately ΔΦ from Φ₁, where ΔΦ may be approximately the difference between direction 203 and direction 204, sensor 202 is directed toward peak light intensity direction and/or there is a peak signal I2(Φ₂) 304. In some embodiments, rotations of the spinicator 200 may be calculated using a function of angles Φ₁ and Φ₂ (for example a derivative and/or another function). Optionally the angles and/or a function thereof may be sampled between 1 to 10 times per second and/or between 10 to 100 times per second and/or between 100 to 1000 times per second or more.

FIG. 4 illustrates a graph 400 of a plurality of functions wherein at least one input of each function may be the relative light intensity of photo sensor 201 and sensor 202, in accordance with an embodiment of the current invention. As shown in 400, the horizontal graph axis is identical to that of FIG. 3, and the vertical graph axis indicates the difference between measured light intensity I1(Φ) and I2(Φ). Optionally, as spinicator 200 rotates, instantaneous values of measurements from sensor 201 and sensor 202 are updated and/or compared and/or used for computations at any given time. For example, solid curve 401 is the relative change in intensity ΔI(Φ) over angle ΔΦ. For example, the change of light intensity may be defined as ΔI(Φ)=I1(Φ)−I2(Φ). The dotted curve 402 represents a positive threshold pthrs(Φ) and the dotted curve 403 represents a negative threshold nthrs(Φ). For example, the positive threshold 402 may be defined as pthrs(Φ)=(I1(Φ)+I2(Φ))/K, and negative threshold 403 may be defined as nthrs(Φ)=−(I1(Φ)+I2(Φ))/K, where K is a constant value, for example any real number. For example, a value of K=4 may be used in some embodiments. Further defined is state variable 404 (illustrated in the lowest square wave curve). State variable 404 is defined set at +1 when ΔI(Φ) changes from less than pthrs(Φ) 402 to greater than pthrs(Φ) 402 and state variable 404 is set at −1 when ΔI(Φ) changes from greater than nthrs(Φ) 403 to less than nthrs(Φ) 403. In a situation where there is a direction that has a significant light intensity peak, as spinicator 200 rotates, the state variable with go through a full cycle from −1 to +1 and back to −1 when the spinicator revolves a single complete rotation about rotation axis 205.

FIG. 5 is a block diagram 500 of a spinicator 200, in accordance with an embodiment of the current invention. For example, spinicator 200 may comprise two or more sensor 501 and sensor 502, a DPU (data processing unit) 503, an input interface 505, an output interface 504, a memory 506, and a power supply 507. For example, sensor 501 and/or sensor 502 may comprise sensor 201 and/or sensor 202. Each of sensor 501 and sensor 502 optionally measures a parameter which changes with angle of the spinicator 200. Optionally sensors 501 and 502 each measure the same parameter and/or are oriented at different directions. Sensors 501 and 502 may each output a signal to DPU 503. In some embodiments, DPU 503 executes instructions to perform a counting function to count rotations of a spinicator 200. In some embodiments, sensors 501 and/or 502 may comprise photo sensors and/or DPU 503 may execute instructions to compute a function illustrated in FIG. 4. Optionally, each time the spinicator 200 completes a rotation about rotation axis 205 (e.g. state 404 passes from −1 to +1) DPU 503 registers a rotation of spinicator 200. In some embodiments, there may be more than two sensors and/or the sensors may be directed in more than 2 different directions.

In some embodiments, DPU 503 may compute rotation statistics and/or output rotation statistics to an output interface 504. DPU 503 may comprise a computer microprocessor, a CPU, a computer on a chip, and/or any other type of computing component. For example, output interface 504 may comprise at least one of a liquid crystal display (LCD), touchscreen, alpha-numeric display device, monochrome display device, color display device, dot matrix display, LED (light emitting diode) display, liquid crystal display, seven segment display, vane display, and/or any other type of display or displays. Alternatively or additionally, the communication interface may include a wireless communication device, for example a Bluetooth transceiver and/or a low energy Bluetooth (BLE) transceiver and/or an Internet Of Things (IOT) interface (for example an ID tag and/or a transceiver). For example, DPU 503 may count rotations and output the number of rotations to be displayed on output interface 504. Optionally the rotation counter may be zeroed each time spinicator 200 sits idle, for example when spinicator 200 does not register a rotation for more than 3 seconds and/or more than 1 second and/or between 1 to 10 seconds and/or between 10 to 30 seconds and/or for more than 30 seconds.

In some embodiments, spinicator 200 may include input interface 505. For example, input interface 505 may comprise at least one input button, touch screen, lever, dial, slider, pressure sensitive area, capacitive sensitive area, light sensitive area, sound sensitive area, and/or a touch sensor. For example, input interface 505 may be used to activate and/or deactivate spinicator 200. Alternatively or additionally, spinicator 200 may have an automatic turn off when not used for a period of time (for example does not register a rotation for more than 3 seconds and/or more than 30 second and/or between 30 to 2 minutes and/or between 2 to 10 minutes and/or for more than 10 minutes).

Optionally the input interface may be used to switch between modes of operation of spinicator 200, for example by a specific type input comprising double press, long press, swipe, hard press, and/or any other type of input distinguishable from the activation and/or deactivation input. For example, spinicator 200 may include a simple counting mode, for example as above wherein spinicator 200 outputs a number of rotations each time the spinicator is flipped, and/or a cumulative mode for example where the number of rotations are accumulated over a plurality of flips, and/or a game mode for example for a more than one of players where cumulative statistics are kept for each player over a sequence of flips, and/or a dice mode for example the spinicator may output a number that is a modulus of 1 to 6 and/or 2 to 12 and/or any other number. Optionally the dice mode may be random, for example the counting may start at a random number and/or the numbers may always start from one number, for example 0. Optionally the probability of each number may be adjusted to be equal for an average thrower and/or the numbers may be related to some probability distribution. For example, a skilled and/or experienced user may be able to control the number of rotations calculated by spinicator 200 to be a desired number. Alternatively or additionally, spinicator 200 may include a real time clock and/or output a rate of rotation.

In some embodiments, spinicator 200 may communicate with an external device, for example a smartphone, a tablet, a computer, a camera equipped computing device, and/or any other computerized device. For example, spinicator 200 may include a wireless transmitter and/or receiver for communicating with an external device (for example a Bluetooth and/or BLE transceiver). For example, a user may control spinicator 200 from an external device and/or collect rotation statistics and/or display rotation statistic by the external device. Alternatively or additionally, spinicator 200 may communicate with an external device, for example using output interface 504 and/or indicator areas as described herein below.

In some embodiments, spinicator 200 may include more than two sensors. For example, sensors may be arranged around more than one axis. For example, sensors may be arranged around axis 205 and additional sensors may be arranged around additional axis that are tangential, perpendicular, and/or angularly offset to axis 205. The additional sensors around additional axes may enable spinicator 200 to count rotations around different axes, for example whichever direction and/or orientation spinicator 200 is flipped it will count rotations. Alternatively or additionally, spinicator 200 may have at least two sensors arranged in a single plane. Optionally DPU 503 may only register a rotation when sensors 501 and 502 and/or additional sensors measure a level of input in a specific order, for example to avoid false positives. Alternatively or additionally, DPU 503 may process sensor measurements to identify specific patterns of sensor stimulation, for example a constant period of rotation, an specific axis of rotation, a period of time of continuous rotation, a starting or ending angular orientation relative to the axis of rotations and the like.

In some embodiments, the CPU and/or the output interface and/or the input interface may be included on an external device. For example, a rotation measuring device may include sensors 501, 502. The rotation measuring device may send sensor data to an external device (for example a smartphone and/or another personal computing device). The external device may include CPU 503 and/or output interface 504 for reporting a rotation tally to a user.

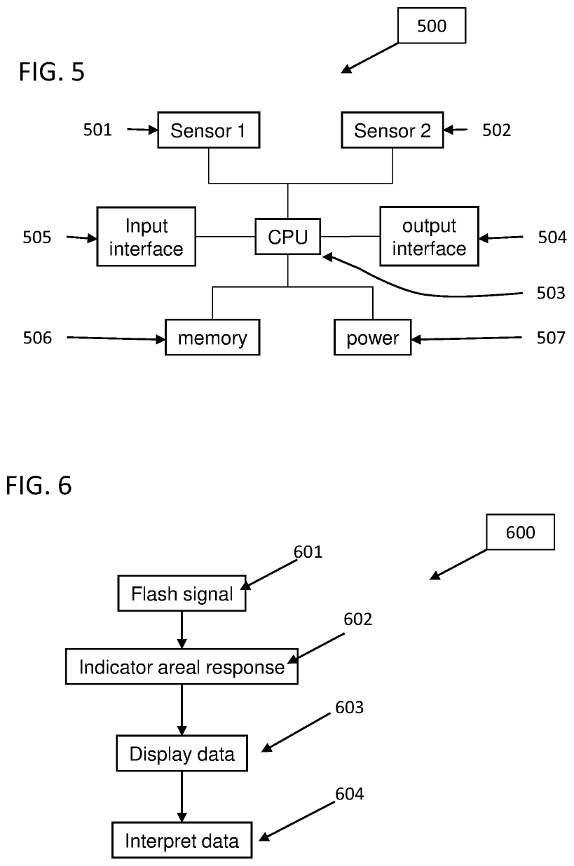

FIG. 6 illustrates flowchart 600 of a method of communicating between two devices using an output interface screen, according to an embodiment of the current invention. For example, a display device may communicate with a camera equipped device. For example, a camera equipped device may comprise at least one of a smartphone, a tablet, a laptop, a camera attached to a computing device, and/or any other computing device equipped with a camera. Optionally, a camera equipped device comprises an area for emitting light, for example an LED, a LCD, an incandescent light, a flash, and/or any other light emitting device. A display device may comprise any device comprising at least one display area, for example an output interface 504. In a preferred embodiment, the display device may be a spinicator 200 and the camera equipped device may be a smartphone equipped with a camera and flash.

In some embodiments, the camera equipped device may flash 601 light towards the display device, according to an embodiment of the current invention. The flash 601 may comprise emitting light, emitting a series comprising periods of emitting light and periods of not emitting light, emitting a single light emission comprising one of at least two predefined light intensities, and/or emitting a series of light emissions wherein each emission comprising one of at least two predefined light intensities. Optionally, the camera equipped device begins recording images of the display area after emitting the flash 601.

In some embodiments, an indicator area on the display device visibly respond 602 to the light flash 601, according to an embodiment of the current invention. For example, the visible response 602 may be a signal which enables the camera equipped device to compute the location and/or orientation of the output interface 504 on the display device. For example, the indicators may be phosphorescent such that after the flash the glow and/or reflection may be identified in a series of images.

Optionally the surface of the display device may comprise at least one indicator area, where the indicator areas may be a reflective area, a glowing area, a textured area, a colored area, a phosphorescent area, and/or any other area visibly distinguishable from the surrounding area of the display device.

Optionally, the display device may comprise sensors, for example sensors 501 and 502, that measure a flash emitted from the camera equipped device and further comprise a data processing unit, for example DPU 503, with capabilities to receive the sensor measurements and identify the flash from the camera equipped device.

In some embodiments, after the flash is identified by the DPU of the display device, the display device begins displaying 603 coded data in the form of a series of segments and/or characters and/or symbols and/or icons, referred to herein as characters, on the display area, according to an embodiment of the current invention. The specific data displayed 603 may be in response to the initial flash or series of flashes.

Optionally, each flash or series of flashes 601 may be an instruction to the display device to display 603 a series of characters and/or may be an instruction regarding how many characters will be communicated and/or how fast and/or at what rate or when to refresh the data display area, referred to herein as a screen. For example, each flash 601 and/or series of flashes 601 as described above may instruct displaying a single screen, displaying 603 a specific number of screens, displaying 603 a predefined number of characters per screen, displaying 603 a specific number of characters, encoding data using a specific set of characters chosen from at least two character sets, a rate of refreshing the displayed characters, ceasing to refresh said characters displayed 603 after a number of times refreshing, and/or any other instruction to the display device relating to a communication protocol, for example a protocol such as IEEE 802.11 (Wi-Fi) and/or IEEE 802.3 (Ethernet) and/or IEEE RFC 205 and/or HD44780, between a display device and a camera equipped device.

Optionally, the characters displayed 603 on the display area may be instructions to the camera equipped device, for example instructions to capture a predefined number of characters, instructions to decode data from a specific set of characters chosen from at least two character sets, a rate at which said display 603 of characters will be refreshed, instructions to cease capturing said characters after a predefined number of times refreshing, and any other instruction to the camera equipped device relating to a communication protocol between a display device and said camera equipped device as described above.

Optionally, the camera equipped device may record images faster than a character rate of the display area.

In some embodiments, the camera equipped device may be configured to execute image recognition processes, for example optical character recognition (OCR), to interpret 604 the displayed coded data in the recorded images and/or series of images, according to an embodiment of the current invention.

Optionally, the camera equipped device may identify the location of the indicator area relative to the display area in one or more images, and use the location of the indicator area to identify the orientation of the display area in the one or more images. For example, the indicator area may enable the image recognition process to correctly identify the character “6” as opposed to the character “9”, since without knowing the orientation the two characters may appear to be indistinguishable.

Optionally a spinicator 200 may include a speaker and/or a microphone and/or communicate with a user and/or other device via sound. Optionally devices may communicate while they are stationary and/or while one or both machines are moving. For example, a spinicator 200 may include an LCD on one or both sides. For example, depending on the direction from which a flash 601 is detected, one or both LCD's may display 603 a message to a camera equipped device.

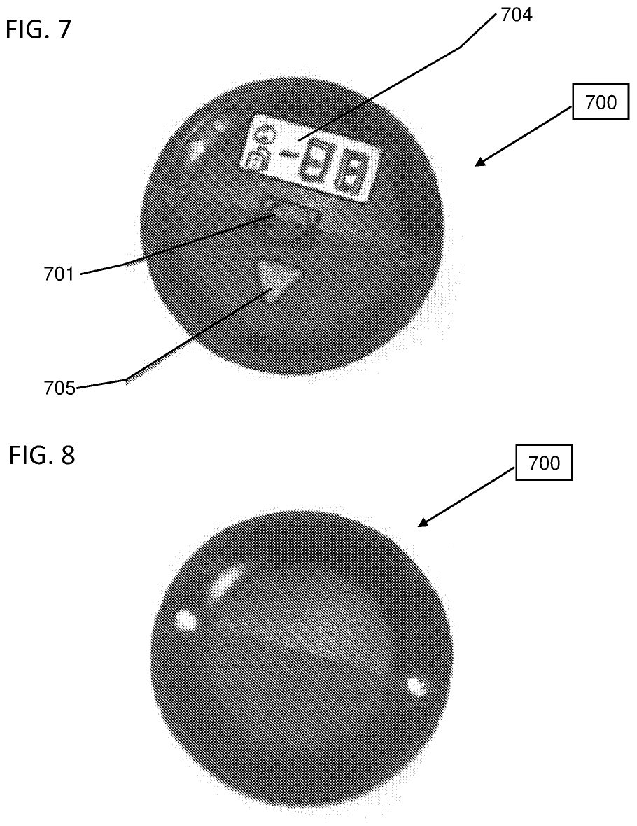

FIGS. 7 and 8 are photographs of a spinicator 700 in accordance with an embodiment of the current invention. For example, a spinicator 700 may be circular with a diameter of between 1 to 10 mm and/or between 10 to 25 mm and/or between 25 to 50 mm and/or between 50 to 100 mm. For example, the thickness of the spinicator 700 may range between 1 to 5 mm and/or between 5 to 12 mm and/or between 12 to 20 mm and/or between 20 to 50 mm.

Optionally, the spincator 700 includes a display 704 and/or an input interface 705 and/or a sensor 701.

A spinicator 700 in accordance with the current invention may be used to play various games. For example, the device may be used to play 21 (a person keeps flipping to cumulate as close as possible to 21 without passing) and/or as a die for any number of possible values and/or to try to come up with as many rotations as possible over a series of flips and/or to get as close as possible to a particular number over a series of flips. The device may be played by a single personal alone (e.g. solitaire) or by two or more individual players and/or in teams. For example, a single die may be simulated by computing a tally equal to the modulus six of the total number of flips. For example, the sum of two dice may be simulated by computing a tally equal to the one plus modulus eleven of the total number of flips. Optionally the modulus function may be weighted to achieve an even and/or uneven probability of values. For example, a modulus 36 function may be used to represent a set of ordered pairs from two individually identifiable dice and/or a modulus 21 function for the unordered combinations of two dice etc.

### Caveat

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

It is expected that during the life of a patent maturing from this application many relevant technologies such as sensors and/or displays will be developed and the scope of the terms is intended to include all such new technologies a priori.

As used herein the term “about” refers to ±5%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. When multiple ranges are listed for a single variable, a combination of the ranges is also included (for example the ranges from 1 to 2 and/or from 2 to 4 also includes the combined range from 1 to 4).

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed:

1. A method of counting rotations of a rotation counting device comprising:
rotating the rotation counting device;
measuring a first intensity of a light arriving to the counting device from a first direction with respect to the device;
measuring a second intensity of a light arriving to the counting device from substantially different second direction; and
calculating a rotation tally of a number of times said rotation counting device rotates about a rotation axis by comparing a series of first light intensities and said second light intensities.

2. The method of claim 1, wherein said measuring of a first light intensity is by a first light sensor on said rotation counting device and said measuring said second light intensity is by a second light sensor on said rotation counting device.

3. The method of claim 1, wherein said rotating includes throwing the rotating device upward.

4. The method of claim 1, wherein said rotating includes applying a differential force on at least two locations on the rotation counting device.

5. The method of claim 1, wherein said rotating includes flipping said rotation counting device like a coin.

6. The method of claim 1, wherein said calculating is by a calculating unit integral to the rotation counting device.

7. The method of claim 1, wherein said first direction and said second direction are determined by at least one member of a group consisting of a position of each of said first sensor and said second sensor on said rotation counting device, a planar alignment of said first sensor and said second sensor relative to each other, light directing slits masking light from at least one direction, polarizing filters and directional light filters.

8. The method of claim 1, wherein said calculation of said rotation tally comprising:
generating a time ordered series of pairs of time correlated values of light intensity measured by said first sensor and said second sensor;
calculating a time ordered series of differential values from said series pairs by subtracting a value of light intensity measured by said first sensor from a time corresponding value of light intensity measured by said second sensor;
calculating a time ordered series of positive threshold values by summing said values of each of said pairs of time series measurements and then dividing each sum by a constant;
calculating a time ordered series of negative threshold values by multiplying each member of said positive threshold series by negative one; and
calculating a cumulative tally by dividing by two a number of times a difference between time correlated values of said differential series and either of said positive or said negative threshold series changes mathematical sign.

9. The method of claim 8, wherein said calculation of said tally further includes applying a mathematical function to said cumulative tally.

10. The method of claim 9, wherein said mathematical function includes at least one of an unweighted modulus, a weighted modulus, an average time to flip and a minimum time to flip.

11. The method of claim 1, wherein said calculating unit further calculates at least one mode of operation chosen from a group consisting of a cumulative mode wherein results of at least two series of time correlated samples are summed, a game mode wherein at least two series of time correlated samples are summed separately, a dice mode wherein a modulus of a calculated number of rotations is calculated, and a clock mode wherein a number of rotations per unit of time is calculated.

12. A rotation counting system that counts rotations of a rotation counting device about a rotational axis, comprising:
a first sensor configured to measure light intensity coming from a first direction in relation to said counting device;
a second sensor configured to measure light intensity coming from a second direction in relation to said counting device;
a rotation counting unit configured to receive a series values of light intensity measurements from said first sensor and said second sensor and to execute an algorithm for calculating a cumulative rotation tally;
a communications unit adapted to communicate a series of characters, comprising said tally;
a memory for storing at least one of said instructions, said series values, said cumulative tally and intermediate values used in said calculation; and
power source providing electric power to power consuming components of said rotation counting device.

13. The system of claim 12, wherein said rotation counting device further comprises a control switch to turn off or turn on power to said power consuming components.

14. The system of claim 12, wherein said rotation counting unit is integral to said counting device.

15. The system of claim 12, wherein said communications unit is integral to said counting device.

16. The communications unit of said rotation counting device of claim 12 comprising at least one member of a group consisting of a screen adapted to displaying characters, a Bluetooth transmitter, a wireless transmitter.

17. The communications unit of said rotation counting device of claim 12 comprising at least one member of a group consisting of an LED screen, an LCD screen and a touch screen.

18. The communications unit of said rotation counting device of claim 12 comprising at least one member of a group consisting of a Wifi transmitter, a radio transmitter, a cellular transmitter.

19. The device of claim 12, wherein said first sensor includes at least one member of a group consisting of a photodetector, a photovoltaic sensor, a photo resistor, a proximity light sensor, a photo diode, a photo transistor, a photoemission detector, a thermal sensor, a photochemical detector.

20. The device of claim 12, wherein said first sensor includes at least one member of a group consisting of a sensor that converts received electromagnetic radiation into an output signal consisting of at least one of voltage, current, and resistance.

21. A method for communicating data from a display device to a camera equipped computing device comprising:
Pointing a field of view of a camera of the camera equipped device towards a display area located on a display device;
emitting a light signal from said camera equipped device indicating to said display device to begin displaying images of characters;
commencing capturing a series of images of said display area with said camera equipped device;
receiving said light signal by said display device;
displaying on said display area said images including at least one coded data message; and
interpreting by said camera equipped device of said at least one coded data message from at least one image from said series of images.

22. The method of claim 21, wherein said displaying including displaying a plurality of characters.

23. The method of claim 21 wherein said data message comprising a number of times said display device has completed rotating about a rotation axis.

24. The method of claim 21 wherein said camera equipped device identifies an orientation of said display relative to said image by locating on said display device an indicator area distinguishable from a surrounding area of said display device.

25. The method of claim 24, wherein said indicator area includes at least one of a group consisting of a reflective area, a glowing area, a textured area, a colored area and a phosphorescent area.

26. The method of claim 21 wherein displaying said light signal comprises at least one member of a group consisting of emitting light, emitting a series comprising periods of emitting light and periods of not emitting light, emitting a single light emission comprising one of at least two predefined light intensities and emitting a series of light emissions wherein each emission comprising one of at least two predefined light intensities.

27. The method of claim 21 wherein at said light signal further includes instruction to said display device relating to a communication protocol between said display device and said camera equipped device.

28. The method of claim 27, wherein said instructions to said display device include instructions to perform at least one action from a group of actions consisting of displaying a predefined number of characters, encoding data using a specific set of characters chosen from at least two character sets, a rate of refreshing said displayed characters and ceasing to refresh said characters displayed after a number of times refreshing.

29. The method of claim 21 wherein at said data message further comprises at least one message to said camera equipped device from a group consisting of instructions to capture a predefined number of characters, instructions to decode data from a specific set of characters chosen from at least two character sets, a rate at which said display of characters will be refreshed and instructions to cease capturing said characters after a predefined number of times refreshing.
